(19) United States
(12) Patent Application Publication
(10) Pub. No.: US 2024/0086773 A1
(43) Pub. Date: Mar. 14, 2024

(54) APPARATUS AND METHOD FOR GENERATING PREDICTION DATA STRUCTURES

(71) Applicant: One Swipe Bets, Ojo Caliente, NM (US)

(72) Inventor: Ben Oppenheimer, Ojo Caliente, NM (US)

(21) Appl. No.: 18/467,274

(22) Filed: Sep. 14, 2023

Related U.S. Application Data
(60) Provisional application No. 63/430,938, filed on Dec. 7, 2022.
(60) Provisional application No. 63/406,384, filed on Sep. 14, 2022.

(51) Int. Cl. G06N 20/00

(52) U.S. Cl. CPC G06N 20/00

(57) ABSTRACT

In an embodiment an apparatus for generating prediction data structures is presented. The apparatus includes a processor and a memory connected to the processor. The processor is configured to obtain at least a media file related to a prediction subject. The processor is configured to determine metadata of the at least a media file. Metadata includes one or more subject tags associated with the at least a media file. The processor is configured to obtain prediction data of a prediction event. The processor is configured to match the at least a media file with the prediction data based on the metadata. The processor is configured to generate, based on the matching of the at least a media file with the prediction data, a prediction data structure. The prediction data structure includes a display of at least a portion of the prediction data overlaid on the at least a media file.

### CROSS-REFERENCE TO RELATED APPLICATION

This application claims priority to and the benefit of U.S. Provisional Application No. 63/406,384, filed Sep. 14, 2022, and U.S. Provisional Application No. 63/430,938, filed Dec. 7, 2022, both of which are incorporated herein by reference in their entirety.

### TECHNICAL FIELD

This disclosure relates to apparatuses and methods involving prediction data structures. In particular, the current disclosure relates to apparatuses and methods for generating prediction data structures.

### BACKGROUND

Prediction data structures of various prediction events can be overwhelming to a user. Prediction data structures may further be presented to users in confusing and unorganized ways. Accordingly, apparatuses and methods for generating prediction data structures can be improved.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an embodiment an apparatus for generating prediction data structures is presented. The apparatus includes a processor and a memory communicatively connected to the processor. The memory contains instructions configuring the processor to perform various tasks. The processor is configured to obtain at least a media file related to a prediction subject. The processor is configured to determine metadata of the at least a media file. Metadata includes one or more subject tags associated with the at least a media file. The processor is configured to obtain prediction data of a prediction event. The processor is configured to match the at least a media file with the prediction data based on the metadata. The processor is configured to generate, based on the matching of the at least a media file with the prediction data, a prediction data structure. The prediction data structure includes a display of at least a portion of the prediction data overlaid on the at least a media file.

In another embodiment, a method of generating a prediction data structure using a computing device is presented. The method includes receiving predication data of at least a prediction event. The method includes categorizing the prediction data into one or more prediction categories. The method includes generating a prediction data structure based on the prediction data. The method includes displaying the prediction data structure to a user through a display device.

### BRIEF DESCRIPTION OF THE DRAWINGS

The foregoing aspects and many of the attendant advantages of embodiments of the present disclosure will become more readily appreciated as the same become better understood by reference to the following detailed description, when taken in conjunction with the accompanying drawings.

FIG. 1 illustrates an exemplary embodiment of a block diagram of an apparatus for generating prediction data structures;

FIG. 2 illustrates an exemplary embodiment of a graphical user interface displaying a prediction data structure;

FIG. 3 illustrates an exemplary embodiment of a prediction data structure database;

FIG. 4 illustrates an exemplary embodiment of a prediction data structure recommendation engine;

FIG. 5 illustrates an exemplary embodiment of a flowchart for a method of generating prediction data structures;

FIG. 6 illustrates an exemplary embodiment of a machine learning model; and

FIG. 7 is an exemplary embodiment of a block diagram of a computing device.

The drawings are not necessarily to scale and may be illustrated by phantom lines, diagrammatic representations and fragmentary views. In certain instances, details that are not necessary for an understanding of the embodiments or that render other details difficult to perceive may have been omitted

### DETAILED DESCRIPTION OF EXEMPLARY EMBODIMENTS

Aspects of the present disclosure can be used to provide predicted data structures to users based on prediction data communicated with one or more third parties. In an embodiment, aspects of the present disclosure may allow for matching of media files to prediction data of prediction events and displaying prediction data structures including the media file and prediction data. In another embodiment, aspects of the present disclosure may allow for machine learning processes to provide recommendations of prediction data structures. In yet another embodiment, aspects of the present disclosure may allow for intuitive and easy to read graphical user interfaces (GUIs) displaying prediction data structures.

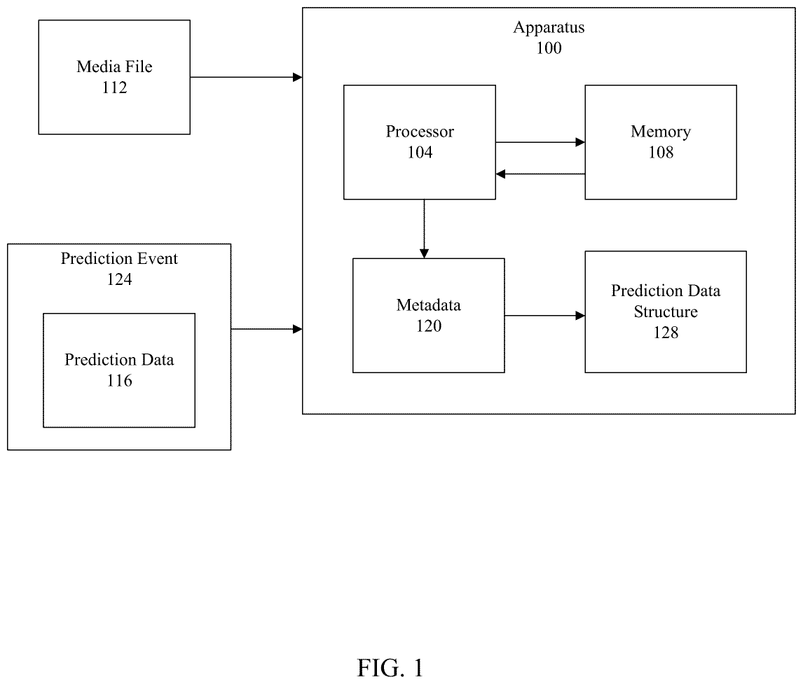

Referring now to FIG. 1, an apparatus 100 for synthetic data generation is presented. The apparatus may include disk storage and/or internal memory, each of which may be communicatively connected to each other. The apparatus 100 may include a processor 104. The processor 104 may enable both generic operating system (OS) functionality and/or application operations. The apparatus 100 may include a memory 108, such as random access memory (RAM). The memory 108 may include instructions configuring the processor 104 to perform various tasks. In some embodiments, the processor 104 and the memory 108 may be communicatively connected. As used in this disclosure, “communicatively connected” means connected by way of a connection, attachment, or linkage between two or more related which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 104 may include any computing device as described in this disclosure, including without limitation a microcontroller, microprocessor, digital signal processor (DSP) and/or system on a chip (SoC) as described in this disclosure. The processor 104 may include, be included in, and/or communicate with a mobile device such as a mobile telephone or smartphone. The processor 104 may include a single computing device operating independently, or may include two or more computing device operating in concert, in parallel, sequentially or the like. Two or more computing devices may be included together in a single computing device or in two or more computing devices. The processor 104 may interface or communicate with one or more additional devices as described below in further detail via a network interface device. Network interface device may be utilized for connecting the processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The processor 104 may include but is not limited to, for example, a computing device or cluster of computing devices in a first location and a second computing device or cluster of computing devices in a second location. The processor 104 may include one or more computing devices dedicated to data storage, security, distribution of traffic for load balancing, and the like. The processor 104 may distribute one or more computing tasks as described below across a plurality of computing devices of computing device, which may operate in parallel, in series, redundantly, or in any other manner used for distribution of tasks or memory between computing devices. The processor 104 may be implemented using a “shared nothing” architecture in which data is cached at the worker, in an embodiment, this may enable scalability of apparatus 100 and/or computing the processor 104.

With continued reference to FIG. 1, processor 104 and/or a computing device may be designed and/or configured by memory 108 to perform any method, method step, or sequence of method steps in any embodiment described in this disclosure, in any order and with any degree of repetition. For instance, the processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

The processor 104 may be configured to obtain media file 112. The media file 112 may include, but is not limited to, images, videos, graphic interchange format (GIFS), and the like. In some embodiments, the media file 112 may include one or more artificial intelligence (AI) generated images, video, and the like, without limitation. The media file 112 may be related to a prediction subject. A “prediction subject” as used in this disclosure is any entity performing in a prediction event. Prediction subjects may include, but are not limited to, athletes such as basketball players, football players, soccer players, tennis players, race car drivers, and/or other athletes. In some embodiments, prediction subjects may include, but are not limited to, celebrities, musicians, actors, chess-players, and/or other entities. A “prediction event” as used in this disclosure is any performance by one or more individuals. Prediction events 124 may include, but are not limited to, sporting events such as basketball games, football games, tennis matches, soccer games, car races, and the like. Prediction events 124 may include, but are not limited to, movies, concerts, comedic stand-up, and/or other performances, without limitation. The media file 112 may include imagery, video, and/or audio of one or more prediction subjects. For instance, the media file 112 may include one or more photographs of one or more prediction subjects. In some embodiments, the media file 112 may include imagery, video, and/or audio of one or more prediction subjects performing one or more actions. For instance and without limitation, the media file 112 may include a GIF of a running back making a running play in a football game. In some embodiments, a prediction subject may include one or more virtual avatars, creatures, machines, and/or other entities. Virtual avatars may include video game characters, virtual reality characters, augmented reality characters, and/or other digitally created entities. Prediction events 124 may include one or more electronic sports (e-sports) events, streaming events, and the like. Prediction events 124 may include video games such as, but not limited to, Overwatch®, Call of Duty®, Super Smash Bros®, Mario Kart®, Tom Clancy's Rainbow Six Siege®, Dead by Daylight®, Counter-Strike:Global Offensive® (CS:GO), StarCraft®, League of Legends®, and/or other video games. For instance and without limitation, prediction event 124 may include an e-sports event of a Street Fighter match between two or more competitors. The media file 112 may include one or more images, videos, and the like of e-sports players and/or virtual characters. As a non-limiting example, media file 112 may include a video or GIF of Blanka from the Street Fighter® series performing a 3 punch combo. Continuing this example, media file 112 may include a video or GIF of Blanka performing a 3 punch combo animation alone or may include a video or GIF of Blanka performing a 3 punch combo animation on another character such as M. Bison.

In some embodiments, the processor 104 may obtain the media file 112 through user input and/or one or more external computing devices. The processor 104 may obtain the media file 112 through one or more third parties, application programming interfaces (APIs), and the like. In some embodiments, the processor 104 may be configured to search through one or more databases for one or more media files 112. Databases may include imagery databases, video databases, audio databases, and the like. The processor 104 may search through the Internet for one or more media files 112. In some embodiments, the processor 104 may utilize a web crawler function. A web crawler function may include a program configured to search through and/or index Internet content. For instance, a web crawler function may be configured to search various websites for data related to and/or media files 112. The processor 104 may search through the internet through one or more search queries. Search queries may include one or more keywords, characters, strings, text, symbols, and the like. In some embodiments, a search query generated or received by the processor 104 may be specific to one or more prediction subjects, prediction events, and the like. For instance, and without limitation, a search query may include keywords such as athlete names, sporting actions, and the like. As a non-limiting example, a query may include a search string such as “James Harden” “three pointer” “Philadelphia 76ers”. A query generated by the processor 104 may include one or more weights. Weights may be indicated of relative importance of one or more keywords in relation to one or more other keywords. Weights may include numerical values that, in combination, may equal 1. In some embodiments, weights may include a percentage value out of 100%, without limitation. For instance, in the above non-limiting example, “James Harden” may be given a weight of 0.8, “three pointer” may be given a weight of 0.1, and “Philadelphia 76ers” may be given a weight of 0.1. The processor 104 may be configured to tune and/or adjust one or more weights of one or more queries. For instance, the processor 104 may adjust weights of one or more keywords of one or more queries. Adjustments of weights may be made based on results of one or more queries or other searches. In some embodiments, a user may adjust one or more weights of one or more keywords and may communicate the weights to the processor 104. In other embodiments, the processor 104 may adjust one or more weights of one or more keywords automatically.

The processor 104 may be configured to utilize an “image downloader tool”, defined herein as software capable of downloading one or more media files from one or more databases. An image downloader tool may be run locally by the processor 104 and/or may be operated in a cloud network and in communication with the processor 104. An image downloader tool may be configured to download a plurality of media files 112 to one or more storage devices. In some embodiments, an image downloader tool may be configured to allow configuration of sources of media files 112 and/or intervals at which media files 112 are downloaded. For instance, an image downloader tool may utilize a queue mechanism. A queue mechanism may include software that places one or more media files 112 into an order of retrieval. An order of retrieval may include an order in which initial media files 112 may be downloaded while subsequent media files 112 may be placed in a hold or queue. Media files 112 placed in a hold or queue may be downloaded after preceding media files 112 are downloaded. Utilization of a queue mechanism may avoid a retriggering of a download of a media file 112 while a previous download of the media file 112 is not completed. A queue of an image downloader tool may be monitored by the image downloader tool and a number of media files 112 being processed in parallel may be increased if a number of media files 112 in the queue is large and may be decreased if the number of media files 112 in the queue is small. In some embodiments, an image downloader tool may have a queue trigger value. A queue trigger value may include a number of media files 112 that if reached triggers parallel processing of two or more media files 112. For instance and without limitation, a queue trigger value may include 10 media files 112. A queue trigger value may be configurable by a user, an image downloader tool, and/or external computing devices. The processor 104 may be configured to operate and/or act as an image downloader tool as described above.

In some embodiments, the processor 104 may be configured to determine metadata of one or more media files 112. Metadata may include data such as, but not limited to, dates, times, file sizes, image resolutions, color data, authors, device identifications, and the like. In some embodiments, metadata of media files 112 may include one or more subject tags. A “subject tag” as used in this disclosure is data conferring information about a media file. For instance, subject tags may include, but are not limited to, prediction subject names, locations, dates, sporting actions, and the like. As a non-limiting example, subject tags may include “Raheem Mostert” “running back” “football” “49ers”. The processor 104 may be configured to match one or more subject tags of one or more media files 112 with one or more keywords of a query. For instance, a prediction subject name may be used as a keyword and may be matched to a media file 112 having metadata reciting the prediction subject name. In some embodiments, the processor 104 may be configured to utilize a metadata machine learning model. A metadata machine learning model may be configured to input media files 112 and output metadata 120. A metadata machine learning model may be trained with training data correlating media files 112 to metadata 120. Training data may be received through user input, external computing devices, and/or previous iterations of processing. The processor 104 may be configured to utilize a metadata machine learning model to process and/or determine metadata 120 of media files 112. For instance, a metadata machine learning model may be configured to identify subject tags, image resolutions, locations, prediction subject names, and the like of one or more media files 112, without limitation.

With continued reference to FIG. 1, results of one or more queries may include a plurality of media files 112, such as, but not limited to, images, videos, GIFs, audio samples, and the like. The processor 104 may be configured to analyze one or more media files 112. For instance, the processor 104 may analyze one or more media files 112 to determine a successful result of one or more queries, such as metadata of a media file 112 matching one or more keywords. In some embodiments, matching of a media file 112 to one or more keywords may include using an image classifier. An image classifier may include a classification algorithm configured to identify one or more prediction subjects from one or more media files 112. An image classifier may be trained with training data correlating one or more media files to one or more prediction subjects. Training data may be received through user input, external computing devices, and/or previous iterations of training. The processor 104 may utilize an image classifier to identify one or more prediction subjects of one or more media files 112. A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Apparatus 100 and/or another device may generate a classifier using a classification algorithm, defined as a processes whereby a computing device derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. An image classifier may be configured to detect prediction subject faces, prediction subject bodies, jersey numbers, and/or other identifying characteristics of prediction subjects. An image classifier may be tuned and/or updated through iterations of processing to more accurately identify prediction subjects.

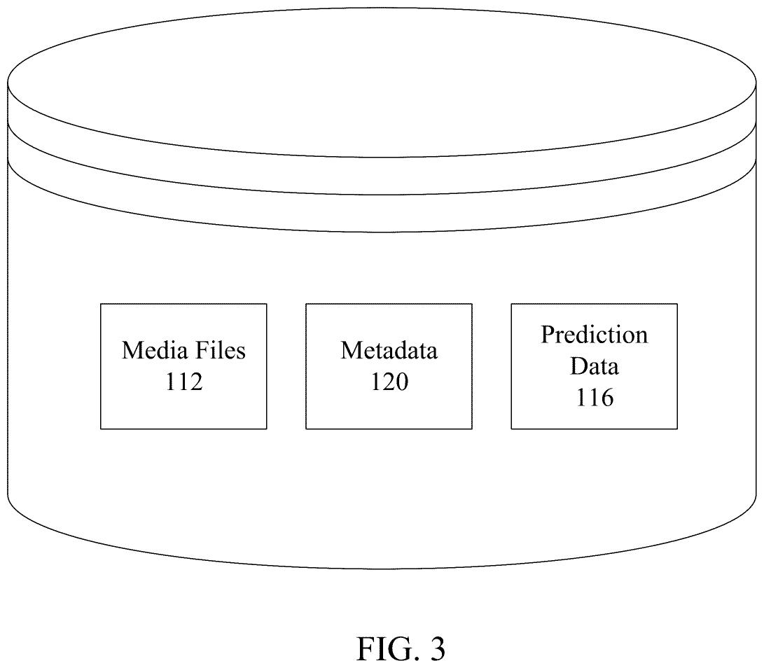

In some embodiments, the processor 104 may be configured to store one or more media files 112, metadata of the one or more media files 112, and/or other data in a database. The processor 104 may be configured to categorize data and/or media files 112 in a database. For instance, a prediction subject's name may be linked to a plurality of media files 112, subject tags, and/or other data in a database. A database may be described in further detail below with reference to FIG. 3.

The processor 104 may be configured to transform, transcode, or otherwise modify one or more media files 112. For instance, the processor 104 may modify one or more media files 112 stored in a database. The processor 104 may transcode one or more media files 112 into one or more formats, sizes, aspect ratios, color codes, and the like. Formats may include, but are not limited to, JPEG, GIF, PNG, HEIF, AVIF, HDR, WEBP, JPEG 2000, TIFF, BMP, PPM, PGM, PBM, PNM, and/or other formats. Sizes may include one or more image resolutions, such as, but not limited to, 640×480 (480p), 1280×720 (720p), 1920×1080 (1080p), 2560×1440 (1440p), 2560×1600 (1600p), 2840×2160 (4K) and/or other resolutions. Aspect ratios may include, but are not limited to, 4:3, 3:2, 16:9, 16:10, 1:1, and/or other aspect ratios. Color codes may include, but are not limited to, RGB, CMYK, HSL, HEX, and/or other color codes. The processor 104 may transform one or more media files 112 based on devices and/or screens the media files 112 may be selected to be displayed through. For instance, a media file 112 may be selected by the processor 104 to be displayed on a smartphone and may be transformed from an original format of JPEG into a PNG. In some embodiments, the processor 104 may utilize a display format machine learning model. A display format machine learning model may include a machine learning model that may modify one or more media files 112 based on one or more display device types. Display device types may include, but are not limited to, smartphones, laptops, tablets, monitors, kiosk screens, and/or other display device types. A display format machine learning model may be trained with training data correlating display device types to media file formats, sizes, aspect ratios, and/or color codes. Training data may be received through user input, external computing devices, and/or previous iterations of processing. A display format machine learning model may be configured to input display types, such as a smartphone model, laptop model, and the like, and output media file 112 formats, sizes, aspect ratios, color codes, and the like. A display format machine learning model may be configured to input one or more media files 112 and/or display device types and output a modified version of the one or more media files 112 to match a display device type. In some embodiments, the processor 104 may utilize one or more auto-scaling workers. An auto-scaling worker may include a program that may automatically adjust a resolution/aspect ratio of one or more media files 112 to match a specific display. Modified media files 112 may be stored in a database with a hash name, metadata, and the like, such as the database described below with reference to FIG. 3.

Still referring to FIG. 1, the processor 104 may be configured to obtain prediction data 116 of one or more prediction events 124. Prediction data 116 may include information relating to prediction event 124. Prediction data 116 may include, without limitation, times, dates, locations, sporting event types, prediction subject names, sports teams, scores, and the like. Prediction data 116 may include information about one or more e-sports competitions, streaming events, and/or other virtual organizations. For instance, prediction data 116 may include e-sports player names, e-sport event names, e-sport player rankings, virtual avatars information, and/or other information. Virtual avatar information may include, but is not limited to, virtual avatar names, cosmetic appearances of virtual avatars such as “skins”, special moves of virtual avatars such as in fighting games, car model of virtual avatars such as in racing games, number of headshots in an Overwatch® game, identity of a player in a play of the game of a Call of Duty®, Overwatch®, or other game, number of player kills in a Defense of the Ancients 2 ® (Dota 2) game, and/or other information. Prediction data 116 may include streaming data of a streaming event, such as stream location, quantity of stream attendees, length of streaming events, streamer information, and/or other information related to streaming. Streaming events may include a broadcast of an individual or group of individuals through one or more computing devices, platforms, and the like. For instance, a streaming event may include an individual playing a video game casually, an e-sports competition, and the like. In some embodiments, prediction data 116 may include a probabilistic outcome. A “probabilistic outcome” as used in this disclosure is a chance probability of an action in a prediction event occurring. For instance, a probabilistic outcome may include, but is not limited to, final scores of games, a number of free throws in a basketball game, an amount of rushing yards for a running back, a number of touchdowns for a football team during a game, number of uppercuts in a fighting game, fighter selected in a fighting game match, finishing place in a racing game, car selected in a racing game, lap time in a racing game, match time of a fighting game, finishing place in a battle royale game, cosmetic appearance selected in a video game such as outfits or “skins” of virtual avatars and/or virtual avatar equipment, and the like. The processor 104 may communicate with one or more third parties, APIs, and the like to obtain prediction data 116 of one or more prediction events 124. In some embodiments, the processor 104 may be configured to analyze prediction data 116 for one or more keywords. For instance, and without limitation, the processor 104 may be configured to analyze prediction data 116 for prediction subject names, prediction event names, dates, times, locations, and the like. The processor 104 may be configured to match prediction data 116 to metadata 120 of one or more media files 112, such as one or more subject tags, without limitation.

The processor 104 may be configured to utilize a prediction data machine learning model. A prediction data machine learning model may be configured to input prediction data 116 and output one or more matching media files 112. A prediction data machine learning model may be trained with training data correlating prediction data 116 to one or more media files 112. Training data may be received through user input, external computing devices, and/or previous iterations of processing The processor 104 may utilize a prediction data machine learning model to extract and/or determine one or more keywords, characters, strings, text, symbols, and the like of prediction data 116 and match the one or more keywords, characters, strings, text, symbols, and the like to one or more media files 112. For instance, a prediction data machine learning model may extract and/or otherwise categorize prediction data 116 to categories such as, but not limited to, prediction subject names, probabilistic outcomes, scores, locations, times, and the like. A prediction data machine learning model may be configured to match one or more words, characters, strings, symbols, and the like from prediction data 116 to metadata 120 of one or more media files 112. As a non-limiting example, prediction data 116 may include “Mike Trout” “Third Base” which may be matched to one or more subject tags reciting “Mike” “Trout” “Mike Trout” “Third Base” and the like of one or more media files 112, which may include media files 112 depicting the baseball player Mike Trout.

In some embodiments, processor 104 may utilize a language processing model, such as a natural langue processing (NLP) classification algorithm, large language model, and/or other language models. A language processing model may be used by processor 104 to associate one or more words, characters, and the like between prediction data 116 and metadata 120. For instance, a language processing model may correlate the word “basketball” of prediction data 116 to various prediction subject names of basketball players, such as “Luka Doncic” or “Trae Young”. The processor 104 may utilize one or both of a language processing model and prediction data machine learning model.

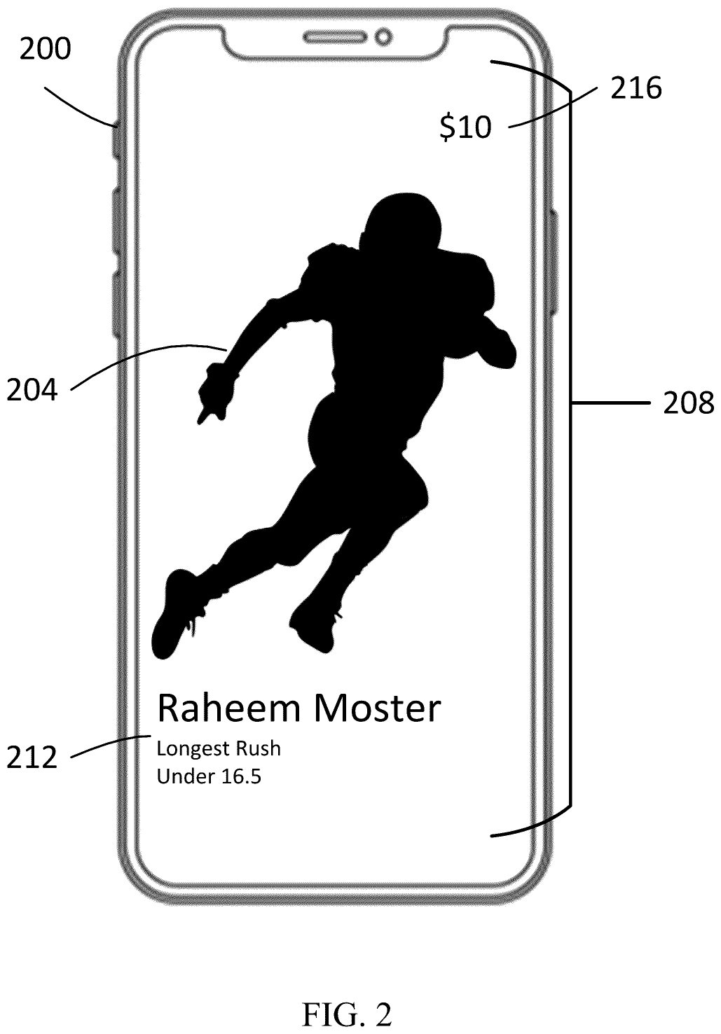

In some embodiments, a match of one or more media files 112 with prediction data 116 may be produced through a prediction data machine learning model and/or by the processor 104. The processor 104 may be configured to generate one or more prediction data structures 128. A “prediction data structure” as used in this disclosure is a collection of prediction data that can be submitted as a wager. A “wager” as used in this disclosure is a placement of one or more possessions of a person on a chance of a probabilistic outcome occurring or not occurring. Wagers may be placed in favor of a probabilistic outcome occurring, against a probabilistic outcome occurring, and/or a combination thereof, without limitation. Wagers may be placed between two or more entities such as, but not limited to, individuals, groups, wagering parties, and the like. Possessions may include, but are not limited to, currency, jewelry, cars, and/or other possessions. Prediction data structures 128 may be submitted as wagers to one or more wagering parties. Wagering parties may include any entity that receives and/or places wagers on prediction events 124. The prediction data structure 128 may include, without limitation, athlete names, locations, times, dates, probabilistic outcomes, currency amounts, and the like. The prediction data structure 128 may include a media file 112 displayed with prediction data 116. For instance, the prediction data structure 128 may include a media file 112 of an image and prediction data 116 displayed over the image. Prediction data 116 may be overlaid on a portion of media file 112 in prediction data structure 128. Prediction data 116 may be overlaid on a bottom, top, left, right, corner, side, center, or other portion of an image, video, and the like of media file 112, without limitation. The prediction data structure 128 may be described below in further detail with reference to FIG. 2.

The processor 104 may be configured to determine, calculate, or otherwise obtain a wager amount relating to prediction data 116. A wager amount may include a value of currency a user may be willing to bet on a probabilistic outcome occurring. Wager amounts may include any currency, such as Euros, Dollars, Yen, and/or any other currency. The processor 104 may be configured to communicate with one or more third parties, APIs, and the like, and obtain prediction data 116 of one or more probabilistic outcomes of one or more prediction events 124. Prediction data 116 may include, without limitation, one or more probabilistic outcomes, currency values, chances of probabilistic outcomes occurring, and the like. Prediction data 116 may include wager data such as, but not limited to, potential profit, potential loss, probabilities of profit, and the like. As a non-limiting example, the processor 104 may determine a wager amount of prediction data 116 of 20$ for a probabilistic outcome of Tyreek Hill to have a longest reception of over 27.5 yards during a football game. As another non-limiting example, the processor 104 may determine a wager amount of 200$ that Scorpion from Mortal Kombat® performs a specific fatality on Sub-Zero during an e-sports game. The processor 104 may adjust wager amounts of prediction data 116 based on data communicated between third parties, such as through one or more APIs.

The processor 104 may be configured to generate one or more prediction data structures 128 based on wager data communicated by one or more third parties through one or more APIs. For instance, prediction data 116 may be generated and/or presented to various client applications via a hypertext transfer protocol application programming interface with REST and/or Graphq1 interfaces. Prediction data 116 may be requested by a time range of validity, by prediction subject, by prediction event, and/or other factors. While prediction data 116 is returned through an API a link to most relevant imagery of the prediction data 116, such as media files 112, may be displayed to a client device. Relevancy of imagery of media files 112 may be determined by a shared number of subject tags of metadata 120 of media file 112 and prediction data 116. For instance, a media file 112 having a highest number of shared tags in metadata 120 with prediction data 116 may be determined to be the most relevant media file 112. Each media file 112 may have one or more relevancy scores associated with predication data 116. Relevancy scores may include a numerical value out of 1, 10, 100, and the like. In some embodiments, relevancy scores may include text such as, but not limited to, “unrelated”, “somewhat related”, “related”, “highly related”, and/or other text. Relevancy scores may expire on a configurable time basis or may be stored for reuse. An API in communication with the processor 104 may allow for a client to query for other media files 112 related to the prediction data 116 in a variety of formats, sizes, color codes, and the like based on one or more display device. A client may be able to request specific media files 112 such as images, videos, specific lengths of videos, and the like. Any of the above described data may be stored in a database, such as a relational database as described below with reference to FIG. 3, without limitation.

Referring now to FIG. 2, a prediction data structure 208 displayed on a graphical user interface is illustrated. The prediction data structure 208 may be similar to and/or the same as the prediction data structure 128 described above with reference to FIG. 1. The prediction data structure 208 may be displayed through display device 200. In some embodiments, the prediction data structure 208 may be displayed through a graphical user interface (GUI) of display device 200. A GUI as used in this disclosure is a computer interface having one or more pictorial elements corresponding to computer functions. Pictorial elements may include, without limitation, graphics, icons, and the like. A pictorial element of a GUI may have a corresponding event handler that may be configured to perform an action upon receiving user input in relation to the pictorial element. For instance, a user may tap an icon on a screen displaying a GUI which may cause the GUI to animate an icon, open an application, and the like. Display device 200 may include, but is not limited to, smartphones, laptops, tablets, monitors, and the like. The display device 200 may include a screen, such as, but not limited to, a liquid crystal display (LCD), organic light emitting diode (OLED) display, active matrix organic light emitting diode (AMOLED) display, and/or other screen type. The predicted data structure 208 may include media file 204. The media file 204 may include, but is not limited to, images, videos, GIFs, and the like. In some embodiments, the media file 204 may be similar to or the same as that of media file 112 as described above with reference to FIG. 1. The media file 204 may include a depiction of a prediction subject, such as, but not limited to, athletes, celebrities, actors, musicians, virtual avatars, e-sports player, and/or other prediction subjects. In some embodiments, the media file 204 may include a depiction of a prediction subject performing an action. Actions may include, but are not limited to, sports moves, instrument playing, scene acting, and the like. For instance and without limitation, the media file 204 may depict a prediction subject scoring a touchdown. The predicted data structure 208 may include prediction data 212. Prediction data 212 may include prediction data 116 as described above with reference to FIG. 1, without limitation. Prediction data 212 may include, but is not limited to, prediction subject names, probabilistic outcomes, dates, times, locations, and the like. As a non-limiting example, prediction data 212 may include text of “Raheem Moster longest rush under 16.5”. Prediction data 212 may be displayed on top of media file 204. For instance, prediction data 212 may be overlaid on a portion of media file 212, such as, but not limited to, a bottom, top, central, or other portion of media file 212. For instance and without limitation, prediction data 212 may be displayed on a bottom left side of media file 212. In some embodiments, prediction data 212 may be contrasted to media file 212, which may improve readability. A computing device may automatically change prediction data 212 to a font, shade, boldness, and the like based on media file 212 to maximize contrast. For instance and without limitation, media file 212 may have a darker background and prediction data 212 may be updated to have a lighter color. A computing device may dynamically adjust font size and/or position of the prediction data 212 based on media file 208. For instance, prediction data 212 may increase in font size, decrease in font size, change font types, increase boldness, italicize, and the like, based on media file 212. As a non-limiting example, media file 212 may depict a swimmer at a bottom portion of display device 200 and prediction data 212 may be displayed at a top center portion of display device 200.

Still referring to FIG. 2, prediction data structure 208 may include wager data 216. Wager data 216 may include one or more currency amounts, average wager amounts, potential profit of a wager, potential loss of a wager, probabilities of winning a wager, probabilities of losing a wager, and the like, relating to a probabilistic outcome of a prediction subject displayed in media file 212. As a non-limiting example, wager data 216 may include a value of $10 in relation to Raheem Moster having a longest rush under 16.5 yards. Wager data 216 may be dynamically adjusted by a computing device for real-time events. For instance, and without limitation, wager data 216 may increase in currency value, decrease in currency value, increase in boldness, decrease in boldness, change color, change positions, and the like. As a non-limiting example, wager data 216 may adjust from a currency value of $10 to a currency value of $5 and may change from a first color of white to a second color of green that may represent the lower currency value of $5.

The predicted data structure 208 may be responsive to one or more user inputs. User inputs may include, but are not limited to, keyboard strokes, mouse input, touch input, and the like. For instance, the display device 200 may include a touch screen that may display the prediction data structure 208. Touch input may include, but is not limited to, taps, long presses, swipes, and/or other forms of touch input. In some embodiments, the prediction data structure 208 may be responsive to touch input received through the display device 200. For instance, a user may swipe left on the prediction data structure 208. A left swipe on the prediction data structure 208 may cause the prediction data structure 208 to animate from an original position on a center of a screen of the display device 200 to a left, upper left, bottom left, or other side of the screen of the display device 200. As a non-limiting example, a user may swipe left on the prediction data structure 208 through a screen of the display device 200 which may cause the prediction data structure 208 to animate to a left side of the screen of the display device 200. Likewise, a user may provide touch input of a right swipe which may cause the prediction data structure 208 to animate to a right side of a screen of the display device 200. In some embodiments, a plurality of prediction data structures 208 may be presented to a user. For instance, a stack of prediction data structures 208 may be presented to a user. A stack may include two or more prediction data structures 208. In some embodiments, a user may provide touch input on a screen of display device 200, which may cause a first prediction data structure 208 to animate to a position off screen and animate a second prediction data structure 208 forward in place of the first prediction data structure 208.

Referring now to FIG. 3, an exemplary embodiment of a prediction database 300 is presented. Prediction database 300 may be implemented, without limitation, as a relational database, a key-value retrieval database such as a NOSQL database, or any other format or structure for use as a database that a person skilled in the art would recognize as suitable upon review of the entirety of this disclosure. Prediction database 300 may operate in a cloud network, local disk storage, and/or other operation. In some embodiments, prediction database 300 may be backed by an array of one or more storage disks. Prediction database 300 may include media files 112. Media files 112 may be as described above with reference to FIG. 1. In some embodiments, media files 112 may be stored under one or more categories. For instance, media files 112 may be categorized into images, videos, GIFs, and the like. In some embodiments, each category of media file 112 may be stored separately from one or more other categories of media files 112. Media files 112 may be categorized by prediction event, prediction subject, and/or other criteria. For instance, prediction database 300 may store media files 112 relating to a first prediction subjects separate from media files 112 relating to a second specific prediction subject. In some embodiments, prediction database 300 may store one or more media files 112 that may be downloaded and/or retrieved by a computing device in communication with prediction database 300, such as processor 104 as described above with reference to FIG. 1, without limitation. Prediction database 300 may store one or more identifiers of one or more media files 112. Identifiers may include, without limitation, perceptual hashes, data hashes, and the like. Perceptual hashes and/or data hashes may include a locality-sensitive hash which may be analogous if features of a multimedia are similar. For instance, a media file 112 of an image may have a perceptual hash identifying the image that may remained the same even if the image undergoes a form of compression, color correction, and/or other modification. Each file of media files 112 may have a corresponding perceptual hash which may identify each media file 112.

In some embodiments, each media file 112 may be stored with one or more tags, such as subject tags. Tags of one or more media files 112 may include, without limitation, prediction subject names, prediction event locations, prediction event dates, prediction event times, prediction event categories, image colors, image resolutions, prediction subject actions, and the like. One or more tags may be associated with one or more media files 112 via a many-tom-any relation to another table in prediction database 300 using an intermediary relations table, which may enable efficient retrieval of imagery locations.

Prediction database 300 may store metadata 120. Metadata 120 may be as described above with reference to FIG. 1. Metadata 120 may include information about media files 112 such as, but not limited to, subject tags, dates, times, locations, device types, image resolutions, image formats, and/or other data. Metadata 120 may be inserted into a datable in prediction database 300 and related to one or more media files 112 using one-to-many relationships leveraging foreign keys, in an embodiment. In some embodiments, one or more media files 112 may be linked to one or more aspects of metadata 120. For instance, and without limitation, a plurality of media files 112 may be linked to a subject tag of metadata 120 reciting “Mike Trout”.

Prediction database 300 may store prediction data 116. Prediction data 116 may be as described above with reference to FIG. 1. In some embodiments, prediction data 116 may include information such as, but not limited to, prediction subject names, prediction subject actions, prediction event type, prediction event location, prediction event date/time, wager amount, and the like. Prediction database 300 may store one or more relationships between media files 112, metadata 120, prediction data 116, and/or any other data described throughout this disclosure, without limitation. Relationships between variables in prediction database 300 may include a linking of two or more variables by relevance. Relevance may be determined by one or more keywords, weights of one or more keywords, prior variable relationships, and the like. As a non-limiting example, prediction data 116 of Patrick Mahomes may have a structural relationship and/or database link to one or more media files 112 that may include depictions of Patrick Mahomes. Relationships may be determined through metadata 120, such as through subject tags and/or other information of metadata 120. In some embodiments, prediction database 300 may be configured to update and/or reorganize links and/or relationships between media files 112, metadata 120, and/or prediction data 116. For instance, prediction database 300 may receive one or more search indexes, such as prediction subject names, prediction event dates, prediction event locations, and the like, and may create one or more relationships and/or links between media files 112, metadata 120, and/or prediction data 116. Prediction database 300 may be configured to store one or more search indexes. Search indexes stored in prediction database 300 may allow for quick retrieval and/or association of media files 112, prediction data 116, and/or metadata 120. Any computing device and/or machine learning model as described throughout this disclosure may reference and/or update prediction database 300, without limitation.

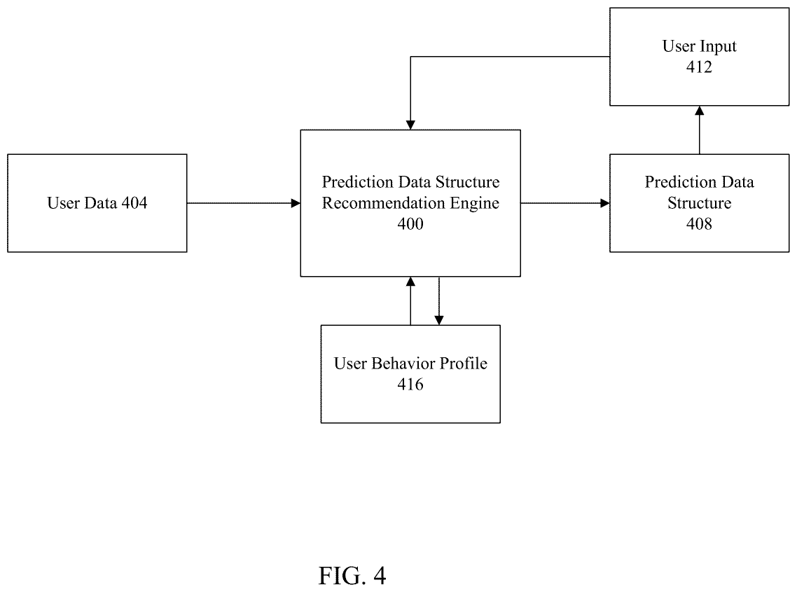

Referring now to FIG. 4, an exemplary embodiment of a prediction data structure recommendation engine 400 is presented. Prediction data structure recommendation engine 400 may include any software and/or hardware as described throughout this disclosure, without limitation. In some embodiments, prediction data structure recommendation engine 400 may include a recommendation machine learning model. A recommendation machine learning model may be trained with training data correlating user data 404 to one or more prediction data structures 408. Training data may be received through user input, external computing devices, and/or previous iterations of processing. A recommendation machine learning model may be configured to input user data 404 and/or user input 412 and output prediction data structures 408. Prediction data structures 408 may be similar to that or the same as prediction data structure 128 as described above with reference to FIG. 1. User data 404 may include information about a user, such as, but not limited to, geographical data, demographic data, prediction event interests, and the like. In some embodiments, user data 404 may be gathered during an onboarding or other process in which a user may provide initial information to a computing device and/or prediction data structure recommendation engine 400. For instance, an onboarding process may include a user filling out various surveys, questionnaires, and the like. Surveys and/or questionnaires may be provided through a computing device such as, but not limited to, smartphones, laptops, tablets, and the like.

Geographical data of user data 404 may include, without limitation, cities, towns, states, internet protocol (IP) addresses, countries, time zones, and the like. Demographic data of user data 404 may include, but is not limited to, ages, household members, working statuses, occupations, races, genders, and the like. Prediction event interests of user data 404 may include, but are not limited to, prediction event types, prediction event categories, prediction subjects, wager tendencies, and the like. Prediction event types may include any prediction event as described throughout this disclosure, such as, but not limited to, sporting events, movies, stand-up comedy, tv shows, e-sports events, streaming events, and/or other events. Prediction subjects may include any prediction subject as described throughout this disclosure, such as, but not limited to, athletes, celebrities, musicians, comedians, and the like. Wager tendencies of user data 404 may include, but are not limited to, average wager amounts, highest wager amount, lowest wager amount, historical wager amount per prediction subject, and the like.

Prediction data structure recommendation engine 400 may input user data 404 and output one or more recommended prediction data structures 408 based on user data 404. As a non-limiting example, user data 404 may show that a user tends to select high wagers for Steph Curry shooting three pointers during a basketball game. Prediction data structure recommendation engine 400 may generate one or more recommended prediction data structures 408 that may include similar wager amounts for one or more other basketball players that may be on a same team, differing team, and the like. One or more weights may be applied to user data 404. For instance, an age may have a weight of 0.2, a most frequently wagered prediction subject may have a weight of 0.6, and an average wager amount may have a weight of 0.2. Weights may be adjusted and/or tuned by prediction recommendation engine 400.

Prediction data structure recommendation engine 400 may communicate wager data between third parties, such as through one or more APIs. Wager data may include, but is not limited to, live stats, odds, feeds, probabilistic outcomes, currency amounts, and the like of one or more prediction subjects and/or prediction events. Prediction data structure recommendation engine 400 may input both wager data and/or user data 404 and output one or more recommended prediction data structures 408.

Prediction data structures 408 may be presented to a user, such as through a display device as described above with reference to FIG. 2, without limitation. Prediction data structures 408 may be presented as a stack or feed of a plurality of prediction data structures 408. A user may provide user input 412 through one or more devices that may be in communication with prediction data structure recommendation engine 400. User input 412 may include, without limitation, keyboard strokes, mouse input, touch input, and the like. User input 412 may include an acceptance or dismissal of one or more prediction data structures 408. For instance, a user may accept a prediction data structure 408 through one or more touch inputs of user input 412, such as a swipe to a right, left, or other direction. Likewise, a user may dismiss one or more prediction data structures 408 through user input 412, such as, but not limited to, touch input of a swipe to a right, left, or other direction. An acceptance of predicted data structure 408 may authorize a wager amount included in predicted data structure 408 to be sent to a wagering party on a user's behalf. A dismissal of predicted data structure 408 may remove predicted data structure 408 from potential submission to a wagering party. Acceptances and/or dismissal of one or more predicted data structures 408 may be used as input by prediction data structure recommendation engine 400. For instance, prediction data structure recommendation engine 400 may learn patterns of which predicted data structures 408 may be accepted by a user and which prediction data structures 408 may be dismissed by a user. Prediction data structure recommendation engine 400 may analyze one or more aspects of accepted and/or dismissed predicted data structures 408, such as, but not limited to, prediction subjects, probabilistic outcomes, prediction events, wager amounts, time of day, locations, and the like. Prediction data structure recommendation engine 400 may generate recommended prediction data structures 408 based on user input 412. User input 412 may be used as input into a recommendation machine learning algorithm, such as described above.

Prediction data structure recommendation engine 400 may be configured to determine and/or generate user behavior profile 416. A “user behavior profile” as used in this disclosure is a collection of data of a user. User behavior profile 416 may include data such as, but not limited to, user wager tendencies, most liked prediction subject, most frequent wagered prediction events, and the like. For instance, user behavior profile 416 may include data showing that a user tends to place about 4 wagers a week having an average currency value of $10 on a prediction subject event of a basketball player on the Lakers basketball team. Prediction data structure recommendation engine 400 may utilize one or more graphing techniques, such as, but not limited to, social graphing, behavioral graphing, and/or other graphing techniques. One or more graphing techniques utilized by prediction data structure recommendation engine 400 may enable prediction data structure recommendation engine 400 to increase relevancy of one or more recommended prediction data structures 408, accuracy of user behavior profile 416, and the like. Social graphing may include comparing user data 404 to data of one or more other users for similar geographical data, demographic data, prediction event interests, and/or other data. For instance, a user may be graphed to one or more other users of a same state, same age group, same wager tendency, and the like. User behavior profile 416 may include one or more graphings of user data 404 to one or more user groups. In some embodiments, a behavioral classifier may be implored. A behavioral classifier may include a classification algorithm that is configured to categorize a user to one or more user groups. A behavioral classifier may be trained with training data correlating user data 404 and/or user input 412 to one or more user groups, such as, but not limited to, wager tendency groups, prediction event groups, prediction subject groups, and the like. Training data may be received through user input, external computing devices, and/or previous iterations of processing. Prediction recommendation engine 400 may utilize a behavioral classifier to categorize user data 404 and/or user behavior profile 416 to one or more categories. Categories of users may include, without limitation, age ranges, locations, frequency of wager submissions, highest amount of wager submissions, lowest amount of wager submissions, most frequently selected prediction subject, most frequently selected prediction event, and/or other categories, without limitation. As a non-limiting example, user data 404 and/or user behavior profile 416 may be classified by a behavioral classifier to an age range of about 18-25, a favorite prediction subject of Jonathan Taylor, a favorite prediction event of Sunday football games, and a favorite probabilistic outcome of rushing for yards. One of ordinary skill in the art, upon reading the entirety of this disclosure, will appreciate the many various categories a user may be categorized to.

Prediction data structure recommendation engine 400 may determine one or more behavioral patterns of a user through user data 404 and/or user input 412. User behavioral patterns may be stored in user behavior profile 416. Behavioral patterns may include, but are not limited to, high engagement of predicted data structures 408, low engagement of predicted data structures 408, regular behavior, irregular behavior, and the like. High engagement of predicted data structures 408 may include a higher frequency of interaction, such as acceptance or dismissal, with prediction data structure 408. Low engagement of predicted data structures 408 may include a lower frequency of interaction with prediction data structure 408, such as lower acceptance or dismissal of prediction data structure 408. Regular behavior may include actions a user may take that may be within an average range of actions for that particular user. An average range of actions may be calculated by prediction data structure recommendation engine 400 based on user data 404, user input 412, and the like. Average ranges of actions may include, but are not limited to, wager amounts, frequency of interaction with prediction data structures 408, locations associated with a user, and the like. For instance, regular behavior may include accepting prediction data structures 408 three nights a week with an average wager amount of $5. Irregular behavior may include one or more actions that are outside an average range of actions for a particular user. For instance, a user may suddenly be accepting prediction data structures 408 having a higher wager amount than normal, such as $50 or $100. Behavioral patterns may be communicated with one or more third parties, such as through one or more APIs, without limitation.

In some embodiments, predicted data structure recommendation engine 400 may utilize collaborative filtering, content-based filtering, hybrid recommendations, and the like. Collaborative filtering may include comparing and/or contrasting similar user input 412 of users to one another. Content-based filtering may include matching descriptions of prediction events/subjects to one or more determined user preferences. Hybrid recommendations may include a combination of collaborative filtering and content-based filtering. In some embodiments, prediction data structure recommendation engine 400 may utilize both a behavioral classifier and a recommendation machine learning model to provide recommended data structures 408. For instance, one or more categories a user may be categorized to by a behavioral classifier may be used as input to a recommendation machine learning model. A recommendation machine learning model may output one or more recommended prediction data structures 408 based on one or more categorization of a user to one or more user groupings. Prediction data structures 408 may be presented to a user in a feed-like manner. For instance, a stack of two or more prediction data structures 408 may be presented to a user through a GUI of a display device. Prediction data structure 408 may have a pre-selected wager amount, prediction subject, prediction event, and the like based on prediction data structure recommendation engine 400. A user may sift through one or more prediction data structures 408 of a stack and/or feed of prediction data structures 408 through user input 412, such as touch input as described above.

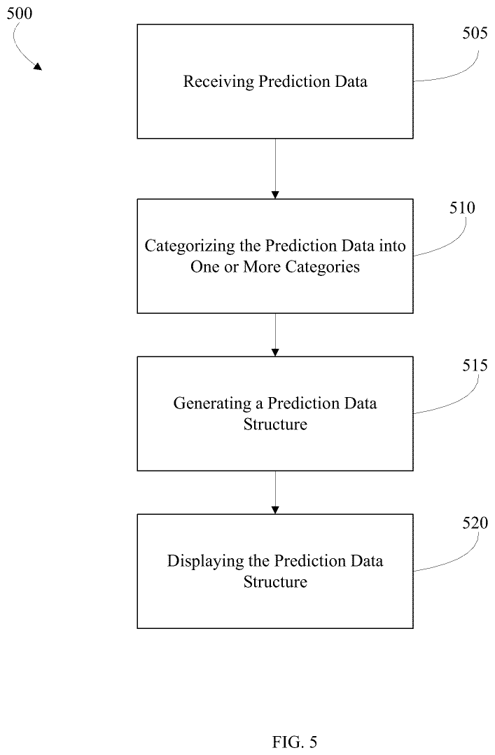

Referring now to FIG. 5, a method 500 of generating a prediction data structure using a computing device is presented. At step 505, method 500 includes receiving prediction data. Prediction data may be received by one or more third parties, through one or more APIs, and the like. Prediction data may include, but is not limited to, prediction subject names, probabilistic outcomes, prediction event categories, dates, times, locations, wager amounts, and the like. Prediction data may be as described above with reference to FIG. 1. This step may be implemented, without limitation, as described above with reference to FIG. 1.

At step 510, method 500 includes categorizing the prediction data into one or more categories. Categories of prediction data may include, but are not limited to, prediction event locations, prediction event categories, prediction subject names, wager amounts, and the like. Categorization may occur through one or more machine learning processes, language models, and the like. This step may be implemented, without limitation, as described above with reference to FIG. 1.

At step 515, method 500 includes generating a prediction data structure based on the prediction data. Generating a prediction data structure may include extracting one or more elements of prediction data and computing one or more elements of a prediction data structure. For instance, prediction data may include a time, location, prediction subject name, and the like, which may be arranged into a prediction data structure. Generating a prediction data structure may include utilizing a prediction data structure recommendation engine, such as described above with reference to FIG. 4. This step may be implemented, without limitation, as described above with reference to FIGS. 1-4.

At step 520, method 500 includes displaying the prediction data structure. The prediction data structure may be displayed through one or more display devices, such as, but not limited to, smartphones, tablets, laptops, and the like. In some embodiments, displaying the prediction data structure may include displaying a stack of prediction data structures. A stack of prediction data structures may include two or more prediction data structures. In some embodiments, each prediction data structure of a stack of prediction data structures may be related to different prediction data. In some embodiments, method 500 may include receiving user input through a display device, User input may include any user input as described throughout this disclosure, without limitation. User input may include an acceptance or dismissal of a prediction data structure. User input may be used in one or more machine learning models to generate a recommended prediction data structure. This step may be implemented, without limitation, as described above with reference to FIGS. 1-4.

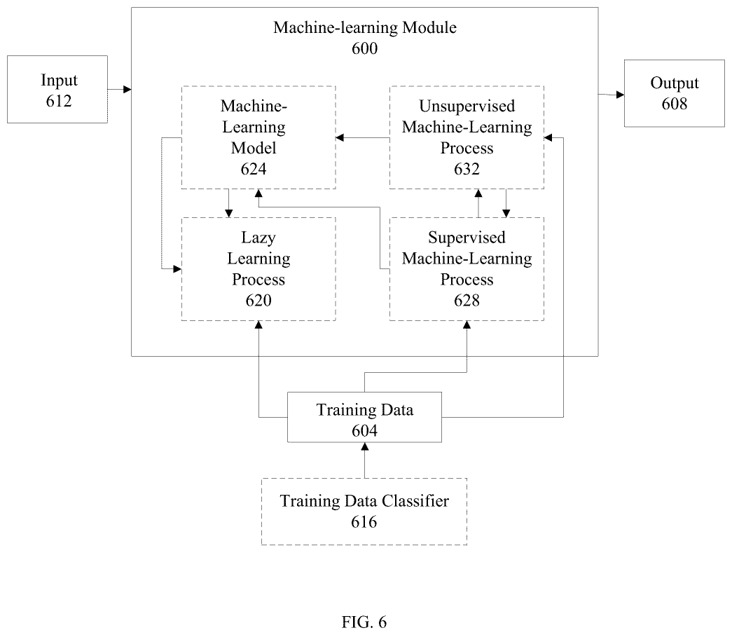

Referring to FIG. 6, an exemplary machine-learning module 600 may perform machine-learning process(es) and may be configured to perform various determinations, calculations, processes and the like as described in this disclosure using a machine-learning process.

Still referring to FIG. 6, machine learning module 600 may utilize training data 604. For instance, and without limitation, training data 604 may include a plurality of data entries, each entry representing a set of data elements that were recorded, received, and/or generated together. Training data 604 may include data elements that may be correlated by shared existence in a given data entry, by proximity in a given data entry, or the like. Multiple data entries in training data 604 may demonstrate one or more trends in correlations between categories of data elements. For instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations. Correlations may indicate causative and/or predictive links between categories of data elements, which may be modeled as relationships such as mathematical relationships by machine-learning processes as described in further detail below. Training data 604 may be formatted and/or organized by categories of data elements. Training data 604 may, for instance, be organized by associating data elements with one or more descriptors corresponding to categories of data elements. As a non-limiting example, training data 604 may include data entered in standardized forms by one or more individuals, such that entry of a given data element in a given field in a form may be mapped to one or more descriptors of categories. Elements in training data 604 may be linked to descriptors of categories by tags, tokens, or other data elements. Training data 604 may be provided in fixed-length formats, formats linking positions of data to categories such as comma-separated value (CSV) formats and/or self-describing formats. Self-describing formats may include, without limitation, extensible markup language (XML), JavaScript Object Notation (JSON), or the like, which may enable processes or devices to detect categories of data.

With continued reference to refer to FIG. 6, training data 604 may include one or more elements that are not categorized. Uncategorized data of training data 604 may include data that may not be formatted or containing descriptors for some elements of data. In some embodiments, machine-learning algorithms and/or other processes may sort training data 604 according to one or more categorizations. Machine-learning algorithms may sort training data 604 using, for instance, natural language processing algorithms, tokenization, detection of correlated values in raw data and the like. In some embodiments, categories of training data 604 may be generated using correlation and/or other processing algorithms. As a non-limiting example, in a body of text, phrases making up a number “n” of compound words, such as nouns modified by other nouns, may be identified according to a statistically significant prevalence of n-grams containing such words in a particular order. For instance, an n-gram may be categorized as an element of language such as a “word” to be tracked similarly to single words, which may generate a new category as a result of statistical analysis. In a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure, without limitation.

Further referring to FIG. 6, training data 604 may be filtered, sorted, and/or selected using one or more supervised and/or unsupervised machine-learning processes and/or models as described in further detail below. In some embodiments, training data 604 may be classified using training data classifier 616. Training data classifier 616 may include a classifier. Training data classifier 616 may utilize a mathematical model, neural net, or program generated by a machine learning algorithm. A machine learning algorithm of training data classifier 616 may include a classification algorithm. A “classification algorithm” as used in this disclosure is one or more computer processes that generate a classifier from training data. A classification algorithm may sort inputs into categories and/or bins of data. A classification algorithm may output categories of data and/or labels associated with the data. A classifier may be configured to output a datum that labels or otherwise identifies a set of data that may be clustered together. Machine-learning module 600 may generate a classifier, such as training data classifier 616 using a classification algorithm. Classification may be performed using, without limitation, linear classifiers such as without limitation logistic regression and/or naive Bayes classifiers, nearest neighbor classifiers such ask-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 616 may classify elements of training data to one or more media files.

Still referring to FIG. 6, machine-learning module 600 may be configured to perform a lazy-learning process 620 which may include a “lazy loading” or “call-when-needed” process and/or protocol. A “lazy-learning process” may include a process in which machine learning is performed upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Still referring to FIG. 6, machine-learning processes as described in this disclosure may be used to generate machine-learning models 624. A “machine-learning model” as used in this disclosure is a mathematical and/or algorithmic representation of a relationship between inputs and outputs, as generated using any machine-learning process including without limitation any process as described above, and stored in memory. For instance, an input may be sent to machine-learning model 624, which once created, may generate an output as a function of a relationship that was derived. For instance, and without limitation, a linear regression model, generated using a linear regression algorithm, may compute a linear combination of input data using coefficients derived during machine-learning processes to calculate an output. As a further non-limiting example, machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include supervised machine-learning process 628. A “supervised machine learning process” as used in this disclosure is one or more algorithms that receive labelled input data and generate outputs according to the labelled input data. For instance, supervised machine learning process 628 may include prediction data as described above as inputs, media files as outputs, and a scoring function representing a desired form of relationship to be detected between inputs and outputs. A scoring function may maximize a probability that a given input and/or combination of elements inputs is associated with a given output to minimize a probability that a given input is not associated with a given output. A scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

Further referring to FIG. 6, machine learning processes may include unsupervised machine-learning processes 632. An “unsupervised machine-learning process” as used in this disclosure is a process that calculates relationships in one or more datasets without labelled training data. Unsupervised machine-learning process 632 may be free to discover any structure, relationship, and/or correlation provided in training data 604. Unsupervised machine-learning process 632 may not require a response variable. Unsupervised machine-learning process 632 may calculate patterns, inferences, correlations, and the like between two or more variables of training data 604. In some embodiments, unsupervised machine-learning process 632 may determine a degree of correlation between two or more elements of training data 604.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm). Coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of I divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought. Similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naive Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

It should also be noted that the present implementations can be provided as one or more computer-readable programs embodied on or in one or more articles of manufacture. The article of manufacture can be any suitable hardware apparatus. In general, the computer-readable programs can be implemented in any programming language. The software programs can be further translated into machine language or virtual machine instructions and stored in a program file in that form. The program file can then be stored on or in one or more of the articles of manufacture.

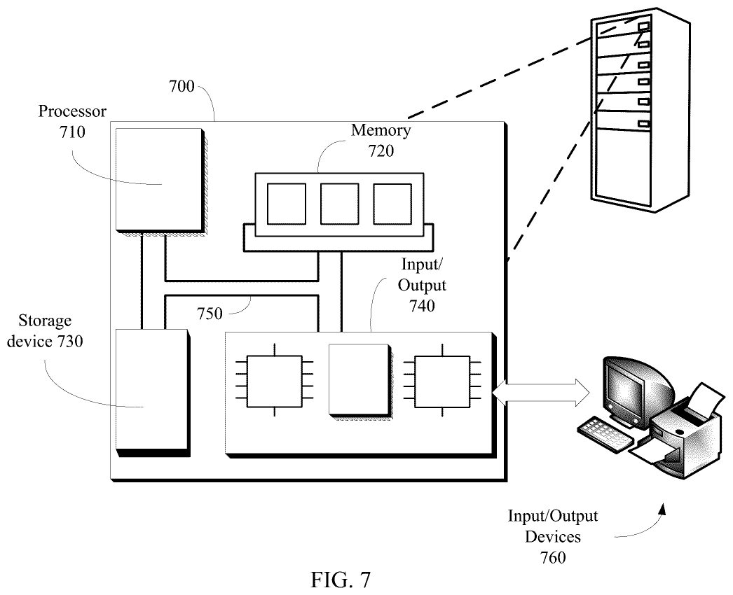

FIG. 7 is a block diagram of an example computer system 700 that may be used in implementing the technology described in this document. General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is a single-threaded processor. In some implementations, the processor 710 is a multi-threaded processor. In some implementations, the processor 710 is a programmable (or reprogrammable) general purpose microprocessor or microcontroller. The processor 710 is capable of processing instructions stored in the memory 720 or on the storage device 730.

The memory 720 stores information within the system 700. In some implementations, the memory 720 is a non-transitory computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a non-transitory computer-readable medium. In various different implementations, the storage device 730 may include, for example, a hard disk device, an optical disk device, a solid-date drive, a flash drive, or some other large capacity storage device. For example, the storage device may store long-term data (e.g., database data, file system data, etc.). The input/output device 740 provides input/output operations for the system 700. In some implementations, the input/output device 740 may include one or more network interface devices, e.g., an Ethernet card, a serial communication device, e.g., an RS-232 port, and/or a wireless interface device, e.g., an 802.11 card, a 3G wireless modem, or a 4G/5G wireless modem. In some implementations, the input/output device may include driver devices configured to receive input data and send output data to other input/output devices, e.g., keyboard, printer and display devices 760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 730 may be implemented in a distributed way over a network, for example as a server farm or a set of widely distributed servers, or may be implemented in a single computing device.

Although an example processing system has been described in FIG. 7, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for generating prediction data structures, comprising:
a processor; and
a memory communicatively connected to the processor, the memory containing instructions configuring the processor to:
obtain at least a media file related to a prediction subject;
determine metadata of the at least a media file, wherein the metadata includes one or more subject tags associated with the at least a media file;
obtain predication data of a prediction event;
match the at least a media file with the prediction data and the metadata; and
generate, based on the matching of the at least a media file with the prediction data, a prediction data structure, wherein the prediction data structure includes a display of at least a portion of the prediction data overlaid on the at least a media file.

2. The apparatus of claim 1, wherein the processor is further configured to generate a recommended prediction data structure through a prediction data structure recommendation engine.

3. The apparatus of claim 1, wherein the processor is further configured to match a media file of a plurality of media files stored in a database with the prediction data based on a determination of the media file having a highest number of shared subject tags with the prediction data.

4. The apparatus of claim 1, wherein the subject tags are weighted by a relevancy score.

5. The apparatus of claim 1, wherein the prediction data includes at least a prediction subject and a probabilistic outcome of the prediction subject related to the prediction event.

6. The apparatus of claim 1, wherein the processor is further configured to:
obtain at least a media file related to a prediction subject;
input the at least a media file into a machine learning model, wherein the machine learning model is trained to input media files and output metadata; and
obtain, based on the machine learning model, metadata of the at least a media file.

7. The apparatus of claim 1, wherein the processor is further configured to communicate the at least a media file and the prediction data to a third party through an application programming interface (API).

8. The apparatus of claim 1, wherein the processor is further configured to modify the at least a media file based on a display device type.

9. The apparatus of claim 1, wherein the processor is further configured to store a plurality of media files and prediction data in a database, wherein the plurality of media files and prediction data are linked to each other within the database.

10. The apparatus of claim 1, wherein the at least a media file is one of an image, video, or graphics interchange format (GIF) file.

11. A method of generating a prediction data structure using a computing device, comprising:
receiving predication data of at least a prediction event;
categorizing the prediction data into one or more prediction categories;
generating a prediction data structure based on the prediction data; and
displaying the prediction data structure to a user through a display device.

12. The method of claim 11, further comprising:
receiving user input through the display device; and
updating a prediction data structure recommendation engine based on the user input.

13. The method of claim 11, wherein displaying the prediction data structure further comprises displaying at least a stack of prediction data structure to the user through the display device, wherein each prediction data structure of the at least a stack of prediction data structures is associated with different prediction events.

14. The method of claim 11, further comprising providing, updating the prediction data structure in real-time based on the prediction data of the prediction event.

15. The method of claim 11, further comprising:
obtaining geographical data of the user;
inputting the geographical data to the prediction data structure recommendation engine; and
generating, based on the prediction data structure recommendation engine, a prediction data structure.

16. The method of claim 11, further comprising generating, based on the user input, a user behavior pattern of the user.

17. The method of claim 16, further comprising generating another prediction data structure based on the behavior pattern of the user.

18. The method of claim 11, wherein the prediction event is happening in real-time.

19. The method of claim 11, further comprising determining a recommended prediction data structure for the user through social graphing.

20. The method of claim 11, further comprising:
receiving user data;
categorizing the user to a user group based on the user data; and
generating a prediction data structure recommendation based on the categorization.
